(19) United States
(12) Patent Application Publication
(10) Pub. No.: US 2006/0114395 A1
(43) Pub. Date: Jun. 1, 2006

(54) Liquid crystal display device and method of fabricating the same

(76) Inventor: Soon-Wook Kwon, Suwon-si (KR)

Correspondence Address: CHRISTIE, PARKER & HALE, LLP, PO BOX 7068, PASADENA, CA, 91109-7068, US

(21) Appl. No.: 11/284,464

(22) Filed: Nov. 21, 2005

(30) Foreign Application Priority Data
Nov. 29, 2004 (KR) 2004-98884

(51) Int. Cl. G02F 1/1343

(52) U.S. Cl. 349/139

(57) ABSTRACT

A liquid crystal display device (LCD) and method of fabricating the same are provided, in which in an OCB mode LCD, an edge portion of a first electrode is formed with a taper angle of not less than approximately 25° and less than 90°, thus an electric field in the edge portion of the first electrode becomes nonuniform so that a transitional nucleus is easily created and liquid crystals are readily transitioned to a bend phase at a low transition voltage. As a result, the phase transition of the liquid crystals can be easily controlled.

### CROSS-REFERENCE TO RELATED APPLICATION

This application claims priority to and the benefit of Korean Patent Application No. 10-2004-0098884, filed Nov. 29, 2004, the entire content of which is incorporated herein by reference.

### BACKGROUND OF THE INVENTION

1. Field of the Invention

The present invention relates to a liquid crystal display device (LCD) and a method of fabricating the same and, more particularly, to an LCD having a first electrode with a taper angle of not less than approximately 25° and less than 90° and a method of fabricating the same.

2. Description of the Related Art

In recent years, the shift to an information-oriented society has been accelerated along with developments in display devices that process and display a large quantity of information. Up to modern times, cathode-ray tubes (CRTs) have been widely used and developed as display devices, but they are heavy, large-sized and require high power consumption.

To solve these problems, flat panel displays (FPDs) began to attract attention. Among them, more attention has been paid to liquid crystal display devices (LCDs), which are thin, light weight and consume relatively low power.

The operating principle of the LCDs is based on the optical anisotropy and polarization of liquid crystals. Since the liquid crystals have a long structure, their molecules are arranged with orientation, and the direction in which the molecules are arranged can be controlled by artificially applying an electric field to the liquid crystals. By controlling the direction in which the molecules are arranged due to the electric field, the optical anisotropy of the liquid crystals can be controlled. Thus, light transmitting through the liquid crystals can be controlled so as to display images on the LCD panel.

In order to obtain LCDs having a fast response speed and a wide viewing angle, an optically compensated bend (OCB) mode LCD has been developed.

In an OCB mode LCD, when alignment layers are formed on a pixel electrode and a common electrode, respectively, the alignment layers are rubbed in the same direction. Also, liquid crystals are injected between the pixel electrode and the common electrode, and then a relatively high voltage is applied to the liquid crystals in an early stage so that the liquid crystals transition from a splay phase to a bend phase. Thereafter, the liquid crystals are turned on/off, thereby enabling the LCD to display image information.

FIGS. 1A and 1B are a plan diagram and a cross-sectional diagram, respectively, of a conventional LCD. FIG. 1B is a cross-sectional diagram taken along the line I-I′ of FIG. 1A.

Referring to FIG. 1A, scan lines 102 and data lines 103 are formed on a substrate 101. In this case, regions partitioned by the scan lines 102 and the data lines 103 can be defined as unit pixels.

A thin film transistor (TFT) 104 including a semiconductor layer, a gate insulating layer, a gate electrode, a source electrode, and a drain electrode is connected to the scan and data lines 102 and 103. The TFT 104 functions as a switching or driving device of each of the pixels.

Also, pixel electrodes 105a and 105b are formed on the source and drain electrodes of the TFT 104. Although not shown in FIG. 1A, OCB mode liquid crystals are filled between the pixel electrodes 105a and 105b and a common electrode (not shown) corresponding thereto.

Referring to FIG. 1B, a first insulating layer 106a is formed on the substrate 101, and the data lines 103 are formed in predetermined regions of the first insulating layer 106a. A second insulating layer 106b is formed to protect the data lines 103, and the pixel electrodes 105a and 105b, of which vertically patterned edge portions A are formed on the second insulating layer 106b.

However, in the conventional LCD, because the edge portions A of the pixel electrodes 105a and 105b are vertically formed, an electric field is uniformly generated between the pixel electrodes 105a and 105b and the common electrode. Accordingly, a high transition voltage and a large amount of time are required in order to allow the liquid crystals filled between the pixel electrodes 105a and 105b and the common electrode to transition from a splay phase to a bend phase.

### SUMMARY OF THE INVENTION

One exemplary embodiment of the present invention, therefore, solves aforementioned problems associated with conventional devices and methods by providing a liquid crystal display device (LCD) and a method of fabricating the same, in which an edge portion of a first electrode is formed with a taper angle of not less than approximately 25° and less than 90° so that the phase transition of liquid crystals can be easily controlled.

In an exemplary embodiment of the present invention, an LCD includes: a first substrate; a first electrode disposed on one surface of the first substrate and having tapered edges; a first alignment layer disposed on the first electrode; a second substrate opposite to and spaced apart from the first substrate; a second electrode corresponding to the first electrode and disposed on one surface of the second substrate; a second alignment layer disposed on the second electrode; and a liquid crystal layer disposed between the first and second substrates.

In another exemplary embodiment of the present invention, a method of fabricating an LCD includes: preparing a first substrate and a second substrate; forming a metal interconnection on one surface of the first substrate; forming an insulating layer on the first substrate on which the metal interconnection is formed; forming a first electrode on the insulating layer, the first electrode having a tapered edge with an angle of not less than approximately 25° and less than 90°; forming a first alignment layer on the first electrode; forming a second electrode on one surface of the second substrate; forming a second alignment layer on the second electrode; and placing a liquid crystal layer between the first and second substrates and encapsulating the first and second substrates.

### BRIEF DESCRIPTION OF THE DRAWINGS

The above and other features of the present invention will be described in reference to certain exemplary embodiments thereof with reference to the attached drawings in which:

FIGS. 1A and 1B are a plan diagram and a cross-sectional diagram, respectively, of a conventional liquid crystal display device (LCD);

FIG. 2 is a plan diagram of an LCD fabricated according to an exemplary embodiment of the present invention;

FIG. 3A is a cross-sectional diagram taken along the line II-II′ of FIG. 2;

FIG. 3B is a magnified diagram of a region C of FIG. 3A;

FIG. 3C is a magnified diagram of a region D of FIG. 3A;

FIG. 4 is a cross-sectional diagram illustrating the propagation of phase transition into a pixel; and

FIGS. 5A to 5F are cross-sectional diagrams illustrating a method of fabricating an LCD according to an exemplary embodiment of the present invention.

### DETAILED DESCRIPTION

The present invention will now be described more fully hereinafter with reference to the accompanying drawings, in which exemplary embodiments of the invention are shown. The thicknesses of layers or regions shown in the drawings may have been exaggerated for clarity. The same reference numerals are used to denote the same elements throughout the specification and drawings. When one element (e.g., one layer) is described as being formed on or disposed on another element (e.g., another layer), it may refer to the one element being formed directly on or disposed directly on the another element, or the one element being formed on or disposed on the another element with a third element interposed therebetween.

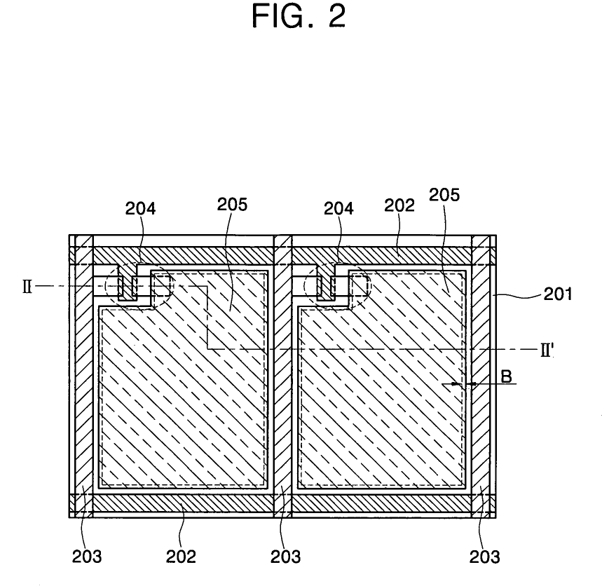

Referring to FIG. 2, which is a plan diagram of a liquid crystal display device (LCD) according to an exemplary embodiment of the present invention, scan lines 202 and data lines 203, which are metal interconnections, are repeatedly formed at predetermined intervals on one surface of a first substrate 201, which is a glass substrate or a plastic substrate. In this case, the scan lines 202 and the data lines 203 are arranged at right angles to each other such that unit pixels are defined by the scan lines 202 and the data lines 203. In the described embodiment of the present invention, although only the scan lines 202 and the data lines 203 are illustrated in the drawings, other metal interconnections such as a common line can be additionally formed.

In each of the unit pixels, a thin film transistor (TFT) 204 including a gate electrode, a gate insulating layer, a semiconductor layer, a source electrode, and a drain electrode is connected to the scan and data lines 202 and 203, and a first electrode 205, which is a pixel electrode, is connected to the source and drain electrodes of the TFT 204.

In this case, either a top gate TFT or a bottom gate TFT can be used as the TFT 204, but the bottom gate TFT is formed in the exemplary embodiments of the present invention.

The first electrode 205 is formed of a transparent conductive insulating material, such as indium tin oxide (ITO) or indium zinc oxide (IZO). The first electrode 205 is formed such that an edge portion B has a taper angle of not less than approximately 25° and less than 90°.

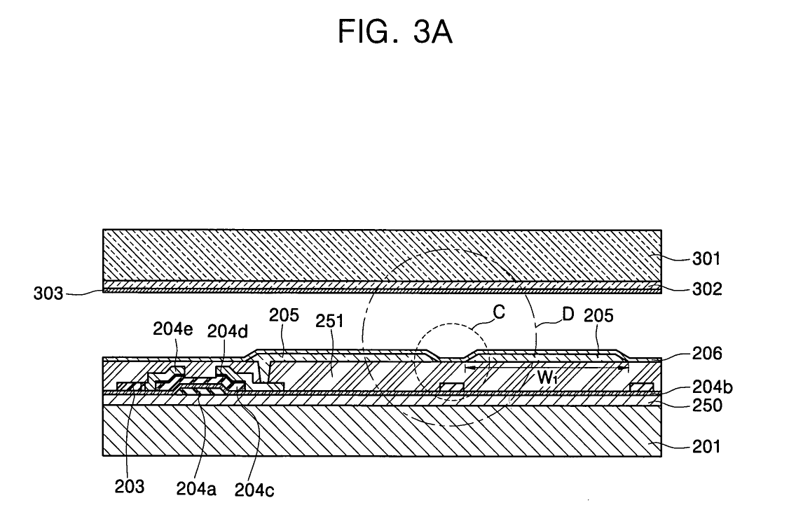

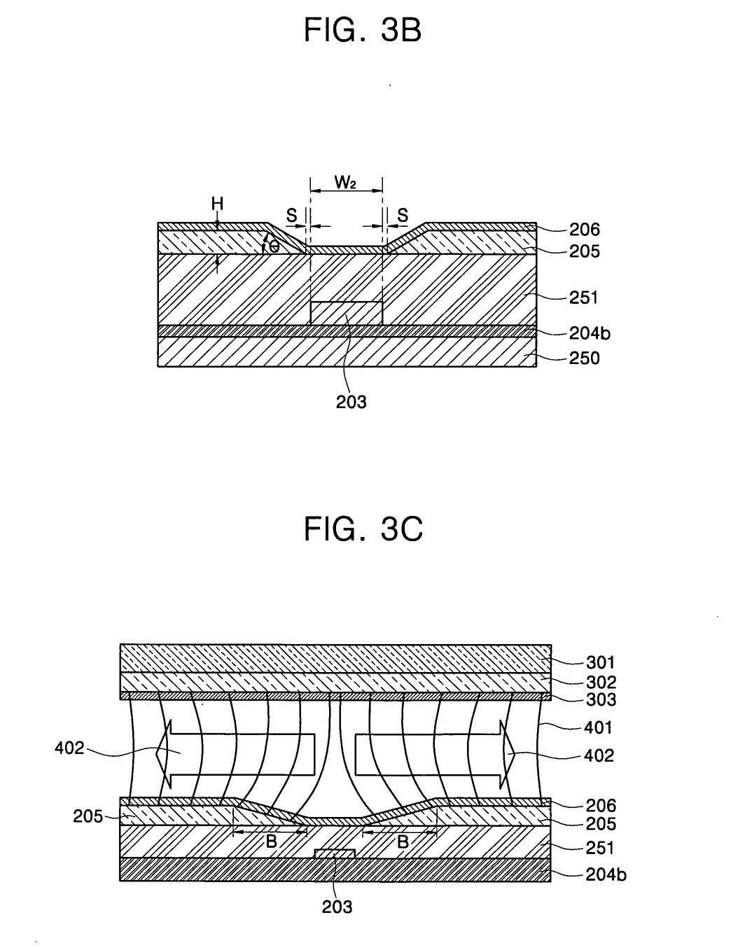

FIG. 3A is a cross-sectional diagram taken along the line II-II′ of FIG. 2, FIG. 3B is a magnified diagram of a region C of FIG. 3A, and FIG. 3C is a magnified diagram of a region D of FIG. 3A.

Referring to FIG. 3A, a buffer layer 250 is deposited on a first substrate 201, which is a glass substrate or a plastic substrate, and a TFT 204 including a gate electrode 204a, a gate insulating layer 204b, a semiconductor layer 204c, an impurity-semiconductor layer 204d, and source and drain electrodes 204e are formed on a predetermined region of the buffer layer 250. A data line 203 and a first electrode 205, which are connected to the source and drain electrodes 204e of the TFT 204, are formed on the gate insulating layer 204b and a planarization layer 251 which is an insulating layer, respectively. Also, a first alignment layer 206 is formed on the first substrate 201 on which the first electrode 205 is formed.

In this case, the first electrode 205 is formed to a width W1 of about 30 to 60 μm.

Further, a second electrode 302, which is a common electrode, is formed on one surface of a second substrate 301, which is a glass substrate or a plastic substrate. Also, a second alignment layer 303 is formed on the second electrode 302.

The first and second alignment layers 206 and 303 are rubbed in the same direction and formed such that a pretilt angle of liquid crystals ranges from approximately 5° to approximately 20°. Each of the first and second alignment layers 206 and 303 is formed of a polymer material, such as polyimide, to a thickness of about 500 to 1000 Å (where Å is 10⁻⁸ cm). In this case, each of the first and second alignment layers 206 and 303 can be formed using a spinning process, a dipping process, or a roller coating process. By way of example, each of the first and second alignment layers 206 and 303 may be formed using the roller coating process.

The first and second substrates 201 and 301 are encapsulated such that the first electrode 205 corresponds to the second electrode 302. A liquid crystal layer (not shown) is formed by injecting or filling OCB mode liquid crystals between the first and second substrates 201 and 301. In this case, the liquid crystal layer includes liquid crystals with positive dielectric anisotropy. Also, since the first and second substrates 201 and 301 are encapsulated to have a gap of about 1.5 to 2.5 μm, the liquid crystal layer filled between the first and second substrates 201 and 301 has a thickness of about 1.5 to 2.5 μm.

Although not shown in FIGS. 3A-3C, a first polarizer may be formed on the other surface of the first substrate 201, and a biaxial compensation film and a second polarizer may be formed on the other surface of the second substrate 301. The polarization axis of the first and second polarizers cross each other.

Although not shown in FIGS. 3A-3C, a reflector sheet, a diffuser sheet, and a backlight unit including light emitting diodes (LEDs) may be additionally formed on the other surface of the first substrate 201. The LEDs may includes red (R), green (G), and blue (B) LEDs and/or cyan (C), magenta (M), and yellow (Y) LEDs. Also, a white (W) LED may be used, but in this case, a color filter should be formed between the second electrode 302 and the second substrate 301.

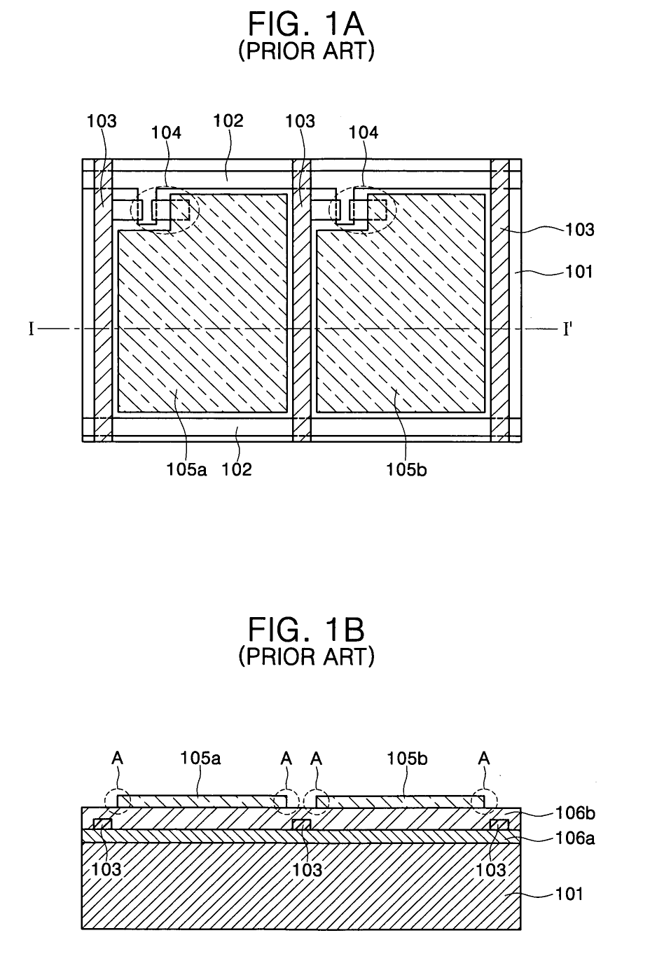

Referring to FIG. 3B, the data line 203 is formed to a width W2 of 4 to 6 μm. Also, the data line 203 and the first electrode 205 are formed to have a space S of 1 to 5 μm, because when the data line 203 and the first electrode 205 are too close to each other, a parasitic capacitor is formed so as to increase leakage current. Generally, if the first electrode 205 has no tapered edges unlike in the described embodiment of the preset invention (e.g., refer to FIG. 1B), the data line 203 and the first electrode 205 should be spaced apart by at least 5 μm. However, when the first electrode 205 has tapered edges as in the described embodiment, as long as the data line 203 and the first electrode 205 are spaced apart by 1 μm or more, substantially no parasitic capacitor is formed.

Also, the first electrode 205 is formed to a thickness H of about 1000 to 3000 Å (where Å is 10⁻⁸ cm).

Further, the first electrode 205 is formed such that a taper angle θ of an edge portion (i.e., an angle of a tapered edge) ranges from not less than approximately 25° and less than 90°. The taper angle θ of not less than approximately 25° and less than 90° can be obtained by calculating the tangent using the thickness H of the first electrode 205 and the length of the tapered edge (i.e., the length of the edge portion of the first electrode 205). Here, by way of example, the length of the tapered edge can. be 4 μm or less.

FIG. 3C shows the distribution of an electric field 401 formed between the first and second electrodes 205 and 302 when a transition voltage is applied therebetween.

Referring to FIG. 3C, the electric field 401 becomes more orthogonal to the planes of the first and second electrodes 205 and 302 and more uniform near the center of the first electrode 205 than in an edge portion B. However, under the influence of the shape of the edge portion B of the first electrode 205, the electric field 401 becomes more non-uniform and concentrated near the edge portion B of the first electrode 205 than at or near the center thereof.

The non-uniformity and concentration of the electric field 401 in the edge portion B facilitates the transition of OCB mode liquid crystals in the edge portion B from a splay phase to a bend phase even at a low transition voltage. That is, a transitional nucleus is easily created.

Hence, the liquid crystals of the liquid crystal layer in the edge portion B readily make the transition to the bend phase at a low transition voltage, and the phase-transitioned liquid crystals lead neighboring liquid crystals to make the phase transition likewise. Thus, the phase transition of liquid crystals propagates from the edge portion B of the first electrode 205 to the center thereof.

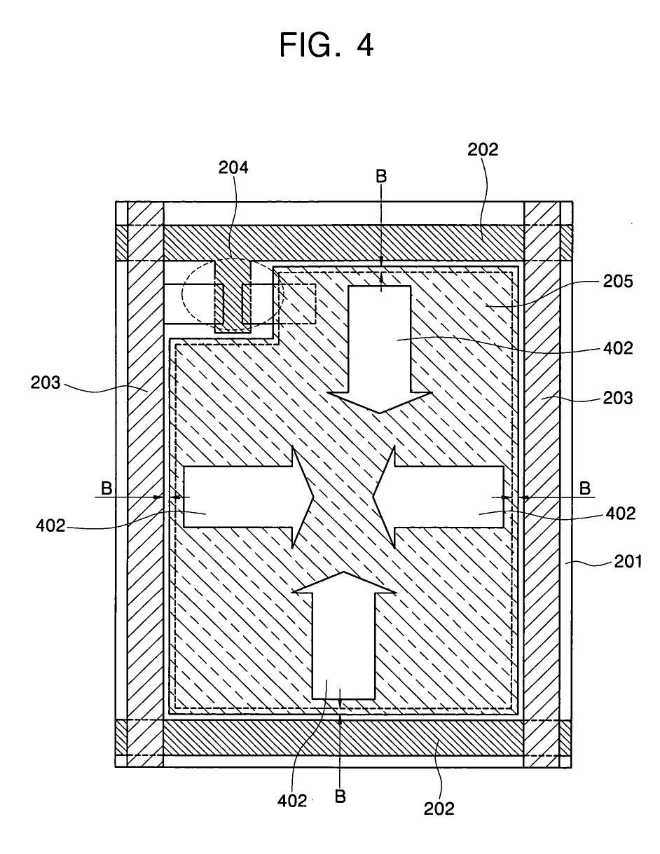

Referring to FIG. 4, it can be seen that the phenomenon as described with reference to FIG. 3C occurs at all edge portions B of the first electrode 205 that are surrounded by the scan line 202 and the data line 203. Thus, the phase transition from a splay phase to a bend phase at a low transition voltage propagates into the first electrode 205, i.e., into a pixel (e.g., refer to arrows 402).

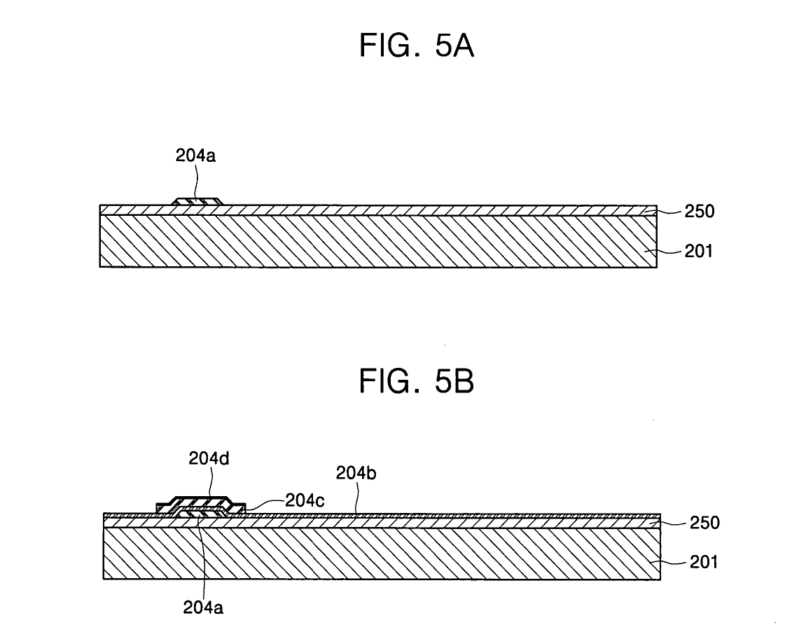

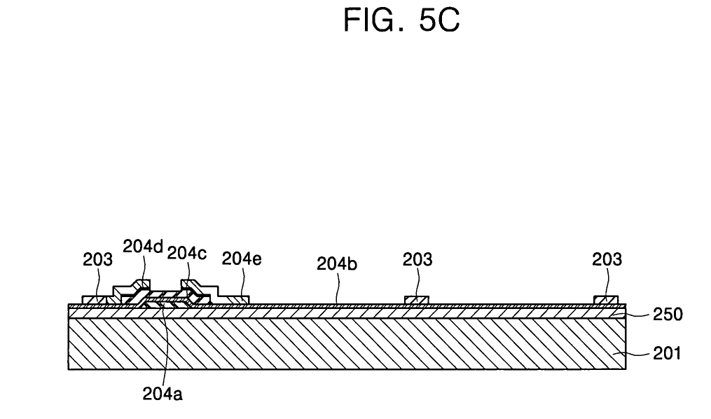

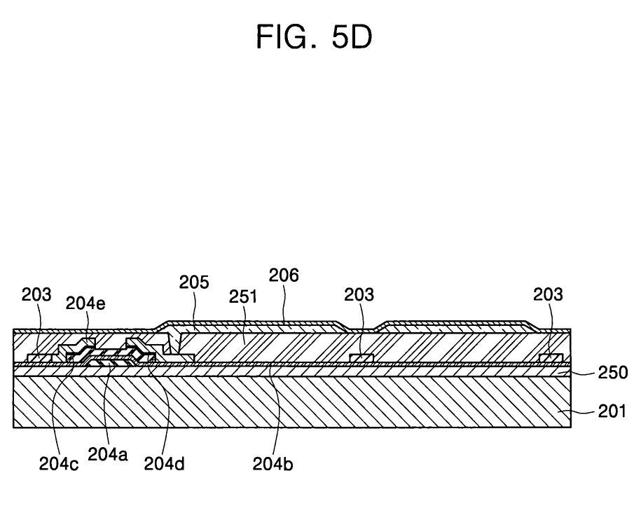

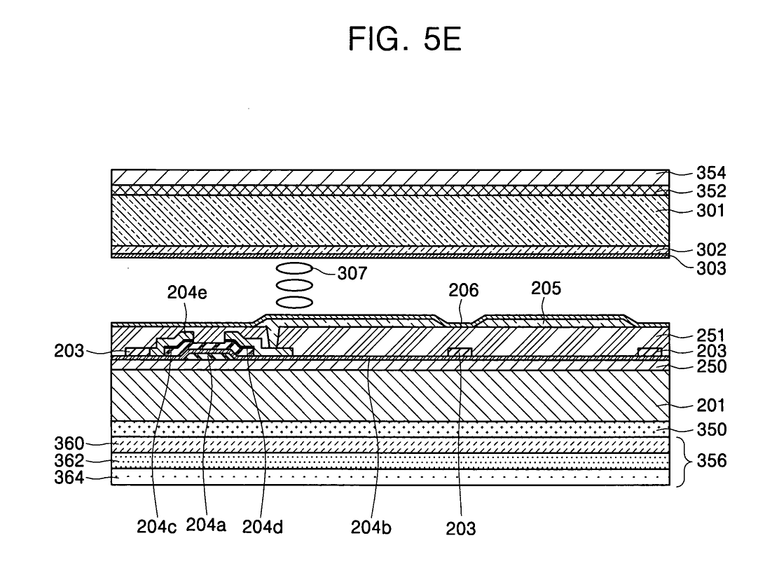

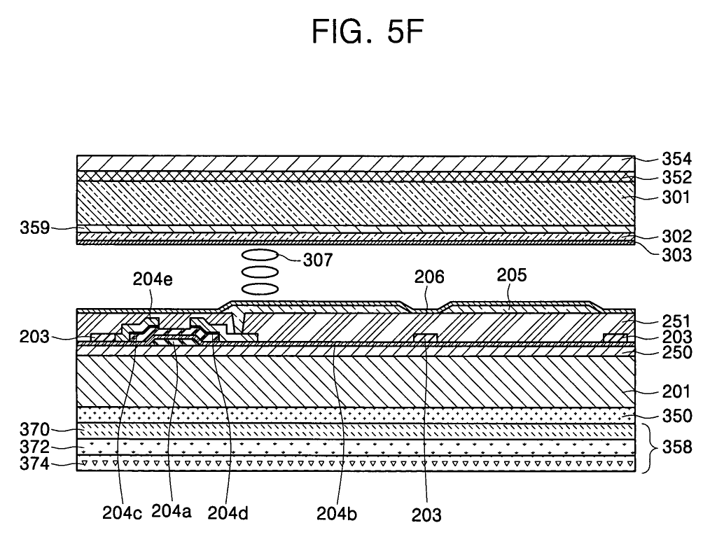

FIGS. 5A to 5F are cross-sectional diagrams illustrating a method of fabricating an LCD according to an exemplary embodiment of the present invention. Some of the elements of the LCD in FIGS. 5E and 5F are shown in a block diagram form as discussed below.

Referring to FIG. 5A, a buffer layer 250 is formed on one surface of a first substrate 201, which is a glass substrate or a plastic substrate. The buffer layer 250 prevents gas or ions, such as moisture or oxygen, which is generated from the underlying first substrate 201, from diffusing or penetrating into upper devices that will be formed later. To perform this function, the buffer layer 250 may, for example, be formed of a silicon oxide layer, a silicon nitride layer, or a multi-layer thereof.

A gate electrode material is formed on the entire surface of the first substrate 201 and patterned, thereby forming a gate electrode 204a and a scan line (not shown).

Referring to FIG. 5B, a gate insulating layer 204b is formed on the first substrate 201 on which the gate electrode 204a and the scan line are formed. The gate insulating layer 204b may be formed of a silicon oxide layer, a silicon nitride layer, or a multi-layer thereof.

Thereafter, a semiconductor layer 204c and an impurity-semiconductor layer 204d are formed on the gate insulating layer 204b. In this case, the semiconductor layer 204c and the impurity-semiconductor layer 204d can be obtained in two ways. In a first method, a semiconductor layer material is formed, and then a thin impurity-semiconductor layer material is formed on the semiconductor layer material using an ion implantation process and patterned, so that the semiconductor layer 204c and the impurity-semiconductor layer 204d are formed. In a second method, a semiconductor layer material and an impurity-semiconductor layer material are stacked and patterned, thereby forming the semiconductor layer 204c and the impurity-semiconductor layer 204d.

Referring to FIG. 5C, a material for source and drain electrodes is deposited on the entire surface of the first substrate 201 and patterned, thereby forming source and drain electrodes 204e and a data line 203.

In this case, a predetermined region of the impurity-semiconductor layer 204d and a predetermined region of the semiconductor layer 204c are etched during the patterning process so that a channel region, a source region, and a drain region are defined in the semiconductor layer 204c. As a result, a back channel etched (BCE) bottom gate TFT can be obtained. Of course, the TFT in exemplary embodiments of the present invention can have an etch stopper (ES) structure instead. In addition, a top gate TFT may be formed in place of the bottom gate TFT.

Referring to FIG. 5D, a planarization layer 251, which is an insulating layer, is formed on the entire surface of the first substrate 201. The planarization layer 251 may be formed of a polymer organic material, such as benzocyclobutene (BCB) or acrylic-based material, using a spin coating method.

Thereafter, a predetermined region of the planarization layer 251 is etched until the source and drain electrodes 204e of the TFT 204 are exposed.

A first electrode material is deposited on the first substrate 201 and patterned, thereby forming a first electrode 205 under the same conditions as described with reference to FIG. 3B.

Subsequently, a first alignment layer 206 is formed on the first substrate 201 and rubbed.

Referring to FIG. 5E, a second substrate 301 (e.g., a glass substrate or a plastic substrate) having one surface on which a second electrode 302 and a second alignment layer 303 are formed is aligned with and located over the first substrate 201 on which the foregoing devices are formed. A liquid crystal layer 307 is formed by injecting or filling liquid crystals (e.g., OCB mode liquid crystals) between the first and second substrates 201 and 301. Thereafter, the first and second substrates 201 and 301 are encapsulated so that the LCD is completed.

In this case, a first polarizer 350 and a backlight unit 356 may be additionally formed on the other surface of the first substrate 201. Also, a biaxial compensation film 352 and a second polarizer 354 may be additionally formed on the other surface of the second substrate 301. In this case, the polarization axes of the first and second polarizers cross each other.

The backlight units 356 and 358 of FIGS. 5E and 5F, respectively, are illustrated in a block diagram form. The backlight unit 356 includes a reflector sheet 364, a diffuser sheet 360 and at least one light emitting diode (LED) 362. The at least one LED can include red (R), green (G) and blue (B) LEDs and/or cyan (C), magenta (M), and yellow (Y) LEDs. In an alternate embodiment, as shown in FIG. 5F, the backlight unit 358 includes a reflector sheet 374, a diffuser sheet 370, and an LED 372, which is a white (W) LED, to realize a color filter type LCD. To provide different colors, a color filter 359 is interposed between the second electrode 302 and the second substrate 301.

In the exemplary embodiments of the present invention as described above, a first electrode is formed with a taper angle of not less than approximately 25° and less than 90°. Thus, an electrical field is non-uniformly distributed so that the transitional nucleus is easily created and the liquid crystals are readily phase-transitioned at a low transition voltage. As a result, the phase transition of the liquid crystals can be easily controlled.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

What is claimed is:

1. A liquid crystal display device comprising:
a first substrate;
a first electrode disposed on one surface of the first substrate and having tapered edges;
a first alignment layer disposed on the first electrode;
a second substrate opposite to and spaced apart from the first substrate;
a second electrode corresponding to the first electrode and disposed on one surface of the second substrate;
a second alignment layer disposed on the second electrode; and
a liquid crystal layer disposed between the first and second substrates.

2. The device according to claim 1, wherein each of the tapered edges has an angle of not less than approximately 25° and less than 90°.

3. The device according to claim 1, further comprising a metal interconnection and an insulating layer interposed between the first substrate and the first electrode.

4. The device according to claim 3, wherein the metal interconnection is a data line.

5. The device according to claim 3, wherein a distance between the metal interconnection and the first electrode is at least 1 μm to 5 μm.

6. The device according to claim 1, wherein the first electrode is formed of a transparent conductive insulating material.

7. The device according to claim 6, wherein the transparent conductive insulating material is indium tin oxide (ITO) or indium zinc oxide (IZO).

8. The device according to claim 1, wherein the first electrode has a thickness of approximately 1000 Å to approximately 3000 Å.

9. The device according to claim 1, wherein the first and second alignment layers are rubbed in a same direction.

10. The device according to claim 1, wherein each of the first and second alignment layers has a pretilt angle of approximately 5° to approximately 20°.

11. The device according to claim 1, wherein each of the first and second alignment layers has a thickness of approximately 500 Å to approximately 1000 Å.

12. The device according to claim 1, further comprising:
a first polarizer disposed on an other surface of the first substrate; and
a second polarizer disposed on an other surface of the second substrate.

13. The device according to claim 12, further comprising a biaxial compensation film interposed between the second substrate and the second polarizer.

14. The device according to claim 12, wherein the first and second polarizers have polarization axes that cross each other

15. The device according to claim 1, wherein the liquid crystal layer has a thickness of about 1.5 to 2.5 μm.

16. The device according to claim 1, wherein the liquid crystal layer includes liquid crystals with positive dielectric anisotropy.

17. The device according to claim 1, further comprising a backlight unit disposed under the first substrate.

18. The device according to claim 17, wherein the backlight unit includes a reflector sheet, a diffuser sheet, and a light emitting diode (LED).

19. The device according to claim 18, wherein the LED includes at least one group selected from a group consisting of red (R), green (G), and blue (B) LEDs and a group consisting of cyan (C), magenta (M), and yellow (Y) LEDs.

20. The device according to claim 18, wherein the LED is a white LED.

21. The device according to claim 1, further comprising a color filter interposed between the second electrode and the second substrate.

22. The device according to claim 1, wherein the liquid crystal layer includes optically compensated bend (OCB) mode liquid crystals.

23. The device according to claim 1, wherein the insulating layer is a planarization layer.

24. A method of fabricating a liquid crystal display device, comprising:
preparing a first substrate and a second substrate;
forming a metal interconnection on one surface of the first substrate;
forming an insulating layer on the first substrate on which the metal interconnection is formed;
forming a first electrode on the insulating layer, the first electrode having a tapered edge with an angle of not less than approximately 25° and less than 90°;
forming a first alignment layer on the first electrode;
forming a second electrode on one surface of the second substrate;
forming a second alignment layer on the second electrode; and
placing a liquid crystal layer between the first and second substrates and encapsulating the first and second substrates.

25. The method according to claim 24, wherein forming the metal interconnection comprises forming at least one selected from a group consisting of a scan line, a data line, and a common line.

26. The method according to claim 24, wherein forming the insulating layer comprises forming a planarization layer.

27. The method according to claim 24, further comprising rubbing the first and second alignment layers in a same direction after forming the first and second alignment layers.

28. The method according to claim 24, wherein encapsulating the first and second substrates comprises encapsulating the first and second substrates such that the first and second substrates have a gap of approximately 1.5 μm to approximately 2.5 μm.
